(19) United States
(12) Patent Application Publication
(10) Pub. No.: US 2008/0127354 A1
(43) Pub. Date: May 29, 2008

(54) Condition based authorization model for data access

(75) Inventors: Matthew Chase Carpenter, Sammamish, WA (US); Xiaoxi Tan, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/605,030

(22) Filed: Nov. 28, 2006

(51) Int. Cl. G06F 21/00

(52) U.S. Cl. 726/28

(57) ABSTRACT

A condition-based authorization model for data access is provided. According to the model, the owner of a securable software object, such as a file, folder, or process, may specify a security policy that includes an access condition for accessing the object. The access condition may be based on dynamic user or system state information having a value that is updatable while a user is logged on, such as system time or user location. When a later request is received from a user to perform an action on the object via an application programming interface of a computer operating system, a security subsystem of the computer operating system queries a system resource containing information suitable to evaluate the access condition, and determines whether the access condition is met. If the access condition is met, access by the user to the securable software object is permitted. Otherwise, access is denied.

### BACKGROUND

Computer operating systems include access control systems to regulate user access to files, folders, and other securable software objects. The access control settings for a particular object are set by its owner or a user who has been granted owner-level or higher privileges, such as administrator. These access control settings are enforced by a security subsystem of the operating system, which verifies that a user who requests the operating system to perform an action on an object, is authorized by the access control settings for that object to perform the requested action.

Most current access control systems enable an owner to regulate access to an object based on the user or group requesting access and the action requested, but not based on other parameters. For computer systems with sophisticated access control requirements, these current access control systems may not provide sufficient flexibility to control access at the operating system level. As a result, developers desiring more flexible access control based on other parameters have been forced to program access control routines at the application-level, on an application-by-application basis. This form of application-level access control may be difficult to scale, slow, less secure, and difficult to deploy system wide as an operating system component.

### SUMMARY

A condition-based authorization model for data access is provided. According to the model, the owner of a securable software object, such as a file, folder, or process, may specify a security policy that includes an access condition for accessing the object. The access condition may be based on dynamic user or system state information having a value that is updatable while a user is logged on, such as system time or user location. When a later request is received from a user to perform an action on the object via an application programming interface of a computer operating system, a security subsystem of the computer operating system queries a system resource containing information suitable to evaluate the access condition, and determines whether the access condition is met. If the access condition is met, access by the user to the securable software object is permitted. Otherwise, access is denied.

### BRIEF DESCRIPTION OF THE DRAWINGS

FIG. 1 is a schematic view of an embodiment of a system for controlling access to a securable software object of a computer operating system.

FIG. 2 is a screen shot of an embodiment of a graphical user interface of a security subsystem of the computer operating system of FIG. 1, configured to enable an owner of a securable software object to enter a security profile including an access condition, on a discretionary basis.

FIG. 3 is a screen shot of an embodiment of a role-based permission entry screen of the security subsystem of the operating system of FIG. 1, from which the graphical user interface of FIG. 2 may be accessed for entry of condition-based security policies.

FIG. 4 is a flowchart of an embodiment of a method for controlling access to a securable software object of a computer operating system.

### DETAILED DESCRIPTION

Overview

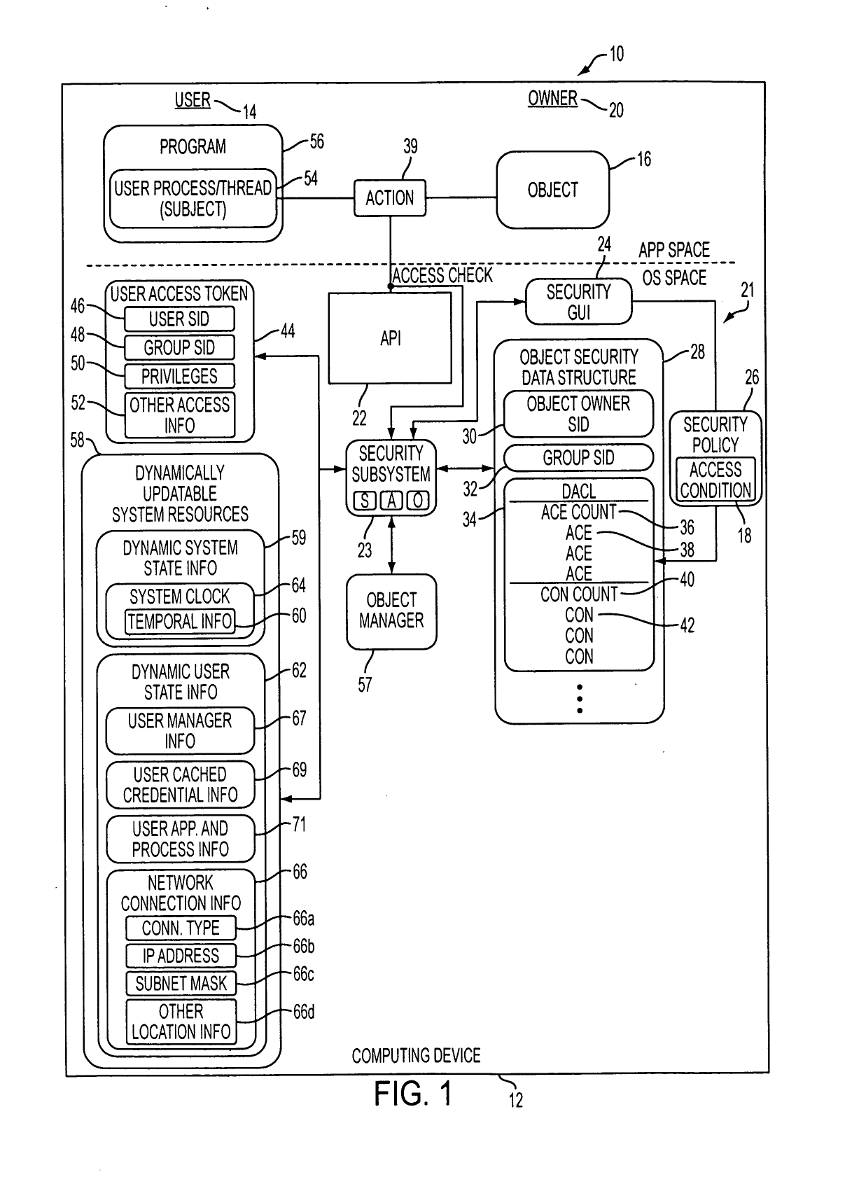

FIG. 1 illustrates a system 10 implemented on a computing device 12, for controlling access by a user 14 to a securable software object 16 based on one or more access conditions 18 designated by an owner 20 of the object. Computing device 12 is typically configured to execute an operating system 21 having an application programming interface (API) 22 via which programs 56 may interface with the operating system. A security subsystem 23 of the operating system is configured to regulate access to object 16, by performing access checks on user requests to access object 16 via API 22, and granting access if access conditions 18 and other access control parameters are met, as described in detail below.

Computing device 12 may be a personal computer, server, mainframe, computer-enabled wireless telephone, portable data assistant (PDA), or other computing device on which a computer operating system is configured to control access to securable software objects. On computing device 12, applications are executed in “application space,” the operating system is executed in “operating system space,” and API 22 functions as a bridge for communications between application space and operating system space. Computing device 12 typically includes a processor connected via a bus to volatile memory (e.g., Random Access Memory), non-volatile memory (e.g., Read Only Memory), and a mass storage device (e.g. a hard drive). The computing device also may include user input devices such as a mouse and keyboard, a display device, and a media drive configured to read media, such as a Compact Disk-Read Only Memory (CD-ROM) or Digital Video Disk-Read Only Memory (DVD-ROM). Software programs including executable code for implementing the embodiments described herein may be stored and distributed on media, loaded onto the computing device via the media drive, saved on the mass storage device, and executed using the processor and portions of volatile memory.

As used herein, the term “securable software object” refers to a software object to which access can be controlled by operating system 21. In the WINDOWS® operating system, a securable software object is any object that can have an object security data structure 28, called a “security descriptor”, which in turn can contain an access control list for the object. Similarly, in the UNIX® and LINUX® operating systems securable software objects include objects that can be secured by access control lists. Examples of securable objects include files and folders, active directory objects, registry keys, network shares, local or remote printers, services, named and anonymous pipes, processes, threads, file mapping objects, access tokens, window management objects (window stations and desktops), interprocess synchronization objects (events, mutexes, semaphores, and waitable timers), job objects, and distributed component object model (DCOM) objects.

Input of Security Policies

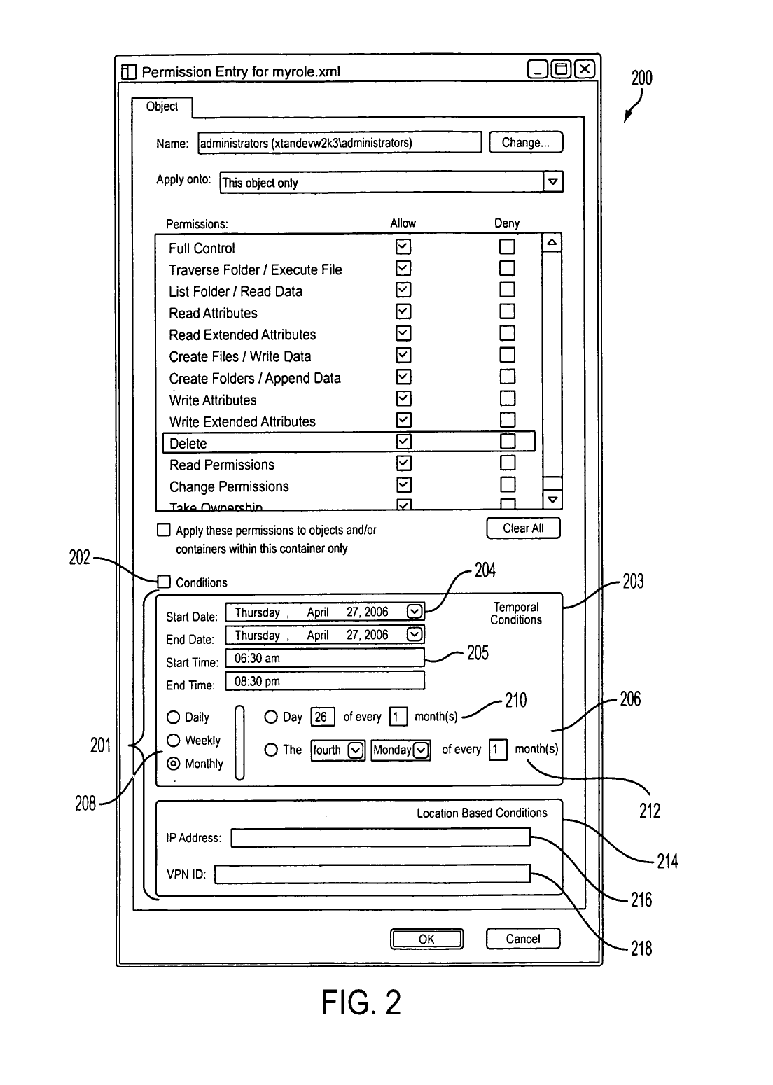

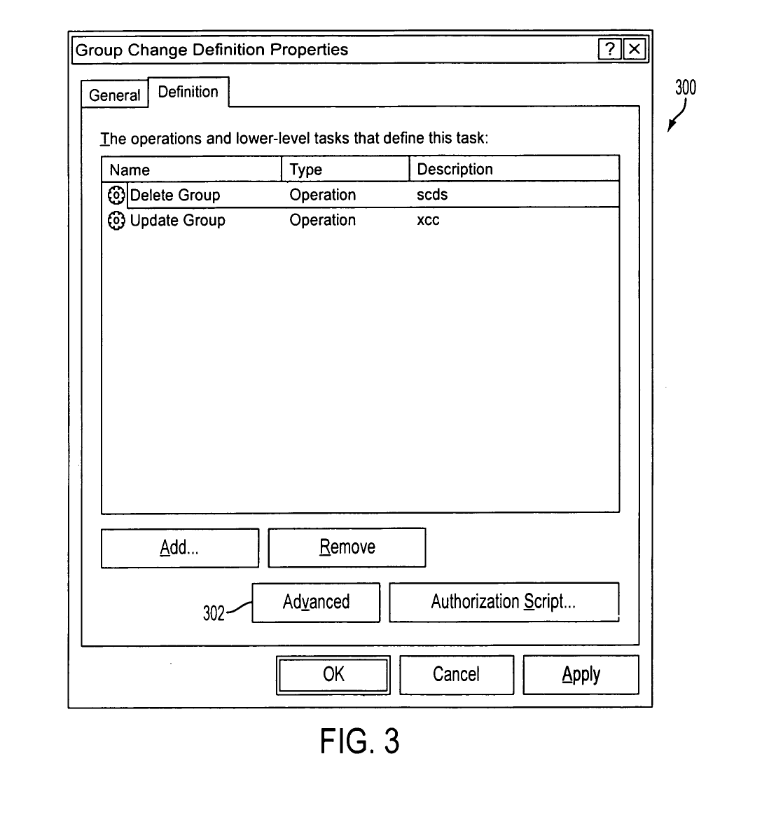

To receive access control settings for object 16, security subsystem 23 is configured to display a security graphical user interface (GUI) 24 to owner 20 of the securable object. Example screens of GUI 24 are illustrated in FIGS. 2 and 3, described below. Via GUI 24, security subsystem 23 is configured to receive a security policy 26 from the owner, which is at least partially based on access condition 18. By way of example, the access condition may be based on dynamic user or system state information, such as a temporal condition or location based condition, as described in detail below. For example, the access condition may specify restricting all access to a file between the hours of midnight and 6 am. Or, the access condition may specify allowing all access to a file from users who logon from computers with network addresses that are on a local subnet. It will be appreciated that one or more temporal and location based access conditions may be simultaneously placed on a software object. This may be used, for example, to limit access to a file between midnight and 6 am except for those accessing from a local subnet. Additional examples of access conditions are given in the EXAMPLES section below. It will further be appreciated that security policy 26 may include other access control information in addition to access condition 18, as described below.

Security subsystem 23 is configured to store the security policy in an object security data structure 28, also referred to as an object security descriptor. The object security data structure may include an object owner's Security Identifier (SID) 30, any group SIDs 32 of the owner, and a Dynamic Access Control List (DACL) 34.

DACL 34 includes a condition entry count 40, as well as a list of condition entries (CONs) 42, which are based on access conditions 18. DACL 34 further includes an access control entry count 36, as well as a list of access control entries (ACEs) 38, based on other access control information that may be included in security policy 26 in addition to access conditions 18.

Since each access condition 18 in security policy 26 is stored as a CON entry 42 in DACL 34, the content of access condition 18 and CON entry 42 is substantively the same. For this reason, CON entries may alternatively be referred to herein as access conditions for ease of reference. CONs 42 are based on dynamic system state information 59 or dynamic user state information 62 that is evaluated by referencing dynamically updatable system resources 58 at the time of requested access. In contrast, ACEs 38 are merely evaluated based on data passed to the security subsystem from the API during an access check function call. The data passed from the API to evaluate ACEs 38 includes the identity of the subject user or group, the requested action, and the object, respectively represented as S, A, and O in FIG. 1. To further illustrate the difference between ACEs 38 and CONs 42, a CON might be used to limit access by users outside of normal business hours, while an ACE might be used to limit access to users who are not members of a defined “manager” group, for example.

It will be appreciated that ACE count 36 and CON count 40 respectively indicate the length (if any) of the list of the ACE or CON entries in the data structure. An ACE or CON count of zero indicates that there are no ACE entries or CON entries, respectively. Therefore, the ACE and CON counts serve as respective mechanisms for determining whether any ACE entries or CON entries exist in the object security data structure.

Enforcement of Security Policies

After owner 20 has input a desired security policy 26 including one or more access conditions 18 for an object 16, security subsystem 23 is configured to enforce the security policy against users who subsequently request access to the object. During the logon process, a unique access token 44 is generated by operating system 21 for each user of computing device 12. This access token provides a security context for actions that user 14 undertakes on the computing device. User access token 44 contains information about the identity and privileges associated with user 14, including a user SID 46, any group SIDs 48 for groups the user belongs to, privileges 50 defining a user's right to perform administrative functions on system resources, and other access information 52, which typically includes static information collected at the time of user logon.

User 14 may request access to object 16 by executing a program 56, such as an application program, utility program, etc., which is run in the user's security context, based on access token 44. To access object 16, program 56 is configured to place a function call to API 22, requesting that an action 39 be performed on object 16. More specifically, program 56 is launched into a process or thread 54 having a user security context based on user access token 44. The process or thread 54 executes instructions of program 56 to make the function call to API 22. Thus, as used herein, a “user request” for access to an object should be understood to encompass requests by user processes or threads to perform actions on securable objects, made on behalf of a user.

Security subsystem 23 is configured to perform an access check on the user request to determine whether user 14 is authorized to perform action 39 on securable software object 16. To initiate the access check, computer operating system 21 is configured to instruct security subsystem 23 to perform the access check on the request. In one embodiment, computer operating system 21 includes an object manager 57 that is configured to monitor requested access to object 16 by API 22. When a user process or thread 54 requests access to an object via an API call, object manager 57 is configured to send a message to the security subsystem 23 to initiate the access check. Alternatively, the computer operating system may initiate the access check in another manner, such as by notification from the API 22 to the security subsystem upon receipt of a user request for access to an object.

Security subsystem 23 is configured to make the determination of whether the user is authorized to perform the action on the object based at least in part on an evaluation of whether the access condition 18 is satisfied. The determination may also be based on other factors, such as whether ACEs 38 are satisfied. To make determinations of whether ACEs 38 are met, security subsystem 23 is configured to receive data indicating an identity of the subject user (S), the action requested (A), and the object (O), as described above. This data may be received from API 22, or alternatively from object manager 57, or other suitable source within computer operating system 21.

To conduct the access check, security subsystem 23 is configured to reference the object security data structure 28 for the requested object 16 to determine whether an access condition has been set by an owner 20 for the requested object 16 by referencing the condition entry count 40. If one or more access conditions have been set, the associated access condition entries 42 in DACL 34 are read by the security subsystem. The security subsystem may also be configured to evaluate whether any access control entries 38 have been set by the owner by referencing ACE count 36, and reading any associated ACEs 38. Where both ACEs 38 and CONs 42 are present in the object security data structure 28, the security subsystem is typically configured to read them in the order they appear in the DACL, with ACEs appearing first as indicated in FIG. 1. This helps ensure compatibility with operating systems that only contain ACEs and no CONs in the DACL, since these operating systems may function by simply ignoring CONs in an ACL, rather than producing an error.

Security subsystem 23 is configured to make reference to information contained in a dynamically updatable system resource 58 containing dynamic system state information 59 or dynamic user state information 62 for evaluating the access condition. Dynamic system and user state information refer to system and user state information that are updatable while a user is logged in to the computer operating system, i.e., during a user logon session, and may be contrasted to data structures such as the user access token, which typically include static information that is not updated during a user logon session.

One example of a system resource 58 containing dynamic system state information 59 is a system accessible clock 64 (such as a system clock or network clock), which contains temporal information 60 such as time, date, day, month, year, etc. It will be appreciated that many other types of dynamic system state information may be utilized, such as processor usage, battery life, connected peripherals, operating system version, system diagnostic information, etc.

One example of a system resource 58 containing dynamic user state information 62 is a network connection information data structure 66 containing network connection type 66a (such as wireless, fixed, virtual private network, local area network, etc.), IP address 66b network subnet mask 66c and other spatial and logical location information 66d. Other examples of dynamic user state information 62 include user manager information 67, user cached credential information 69, and user application and process information 71 on other applications and processes run on behalf of the user. It will be appreciated that a wide variety of other types of user state information may be utilized, such as user security settings, user system settings, etc.

The security subsystem 23 is configured to make the determination of whether user 14 is authorized to perform the action on the object, without API 22 receiving information about access condition 18 from program 56 and without such information being passed along to the security subsystem from application space to operating system space though the API. Rather, access condition 18 is evaluated by reference to system resources containing information for evaluating the access condition. These system resources 58 reside in operating system space. On the other hand, as discussed above, security subsystem 23 is configured to evaluate ACEs based on S, A and O information received from API 22.

After the access check is performed by security subsystem 23, the result is passed back to API 22 from the security subsystem in the form of a message indicating that access is either permitted or denied. API 22 may then fulfill the user request for access to the object if the security subsystem has determined that access is permitted, or may return a message to the program 56 indicating that access is denied; if the security subsystem has determined that access is denied.

FIG. 2 illustrates a discretionary permissions entry screen 200 of security graphical user interface 24, which includes a list of permissions for actions associated with an object. Screen 200 further includes a security policy selection tool 201 configured to receive input of an access condition from an owner of the object. Typically, the inputted access conditions are applied to the action selected by an owner from the permissions list, such as “Delete” in the illustrated example.

Security policy selector 201 further includes a conditions entry selector 202 and a temporal condition selector 203. Upon owner selection of a selected action, such as “Delete” in the illustrated example, access conditions for the selected action may be set by selecting the conditions entry selector 202. The temporal condition selector includes a date range selector 204 and a time range selector 205 by which the owner may enter a date range condition and/or a time range condition, a repeating condition selector 206 by which the owner may specify a recurring day or date for the access condition. The repeating condition selector includes a daily/weekly/monthly selector 208, a date of month selector 210, and a period of month selector 212, which may alternately be selected via radio buttons for flexible entry of the repeating condition. It will be appreciated that these are merely illustrative embodiments, and a wide variety of other selectors may be included that are configured to receive input of a temporal condition from the owner. For example, selectors that enable specification of years, or more complicated patterns such as every other day, may be provided.

Security policy selector 201 of screen 200 also may include a location based condition selector 214, which includes a network address selector 216 which may be configured to receive owner input of an IP address or network subnet mask, and a Virtual Private Network (VPN) selector 218 configured to receive input of a network name for the VPN network type. It will be appreciated that the IP address and VPN network name and network type are merely illustrative examples of possible logical locations, and other selectors may be provided to receive other types of logical locations, or may be configured to receive input of spatial locations, such as building name, street address, city, state, country, active directory location, etc.

GUI 24 is configured to store the access condition 18 that is input into screen 200 in object security data structure 28, either directly or through security subsystem 23. Once entered in the object security data structure, the access condition will be evaluated by security subsystem 23 upon a requested action on the object by a user during a subsequent user logon session.

FIG. 3 illustrates a role-based permissions entry screen 300 of GUI 24, which enables an owner to assign access control permissions by defined roles, i.e., across a defined group. By selecting the “advanced” button 302, the owner may cause the security subsystem to display a security policy selector similar to selector 201 in FIG. 2, to thereby allow input of security policy with access conditions for role-based permissions entry.

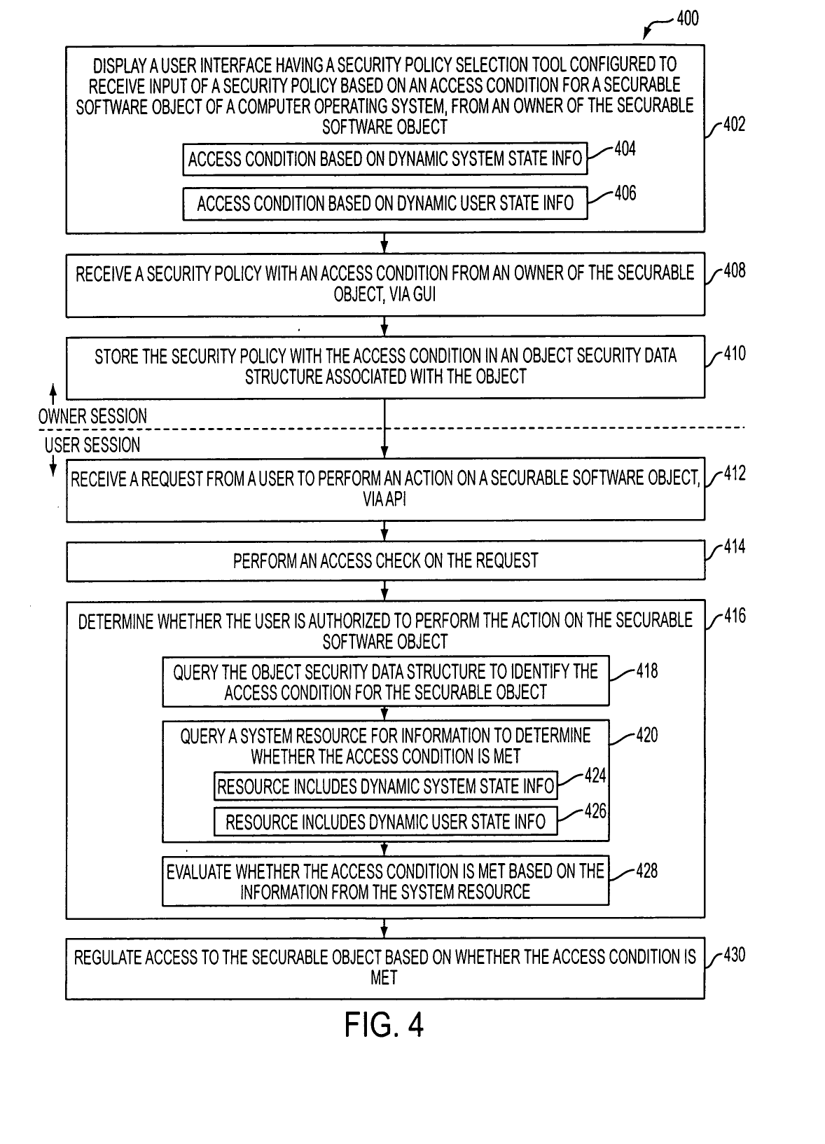

Turning now to FIG. 4, a method for controlling access to a securable software object in a computer operating system is illustrated generally at 400. While the method described hereinafter may be executed using the systems and devices described above, it will be appreciated that other suitable systems and devices may alternatively be used to implement the method. As indicated at 402, the method may include displaying a graphical user interface (GUI) having a security policy selection tool configured to receive input of a security policy from an owner of the securable software object who is authorized to control access settings for the securable software object. As discussed above, the security policy may be at least partially based on an access condition that may be evaluated by a security subsystem of a computer operating system, by making reference to a dynamically updatable system resource. For example, the access condition may be based on dynamic system state information or dynamic user state information that is updatable while a user is logged in to the computer operating system.

As shown at 404, the access condition may be based on dynamic system state information. For example, the access condition may be a temporal condition based on temporal information stored in a system accessible clock. The method may also include displaying a temporal condition selector on the security policy selection tool. The temporal condition selector may be configured to receive input of the temporal parameter from the owner. The temporal parameter, for example, may be selected from parameters such as year, month, date, day and time, as described above.

As shown at 406, the access condition may also be based on dynamic user state information. For example, the access condition may be a location based condition based on a location parameter. The method may further include displaying a location condition selector on the selection tool. The location condition selector may be configured to receive input of a location parameter from the owner. The location parameter may be a logical location, such as a computer network address or a spatial location, such as a city, state, or street address, building number, etc., as described above.

As shown at 408, the method includes receiving the security policy from the owner, which is at least partially based on the access condition. The security policy is received via GUI displayed at step 402, at the security subsystem of the computer operating system, as described above.

As shown at 410, the method includes storing the security policy with the access condition in an object security data structure associated with the object and accessible to the security subsystem. As described above, the security subsystem may be configured to cause the security policy to be stored in the object security data structure. Alternatively, the security policy may be stored directly in the object security subsystem by the GUI at which the security policy is input.

The steps of displaying the GUI, receiving the security policy via the GUI, and storing the security policy take place during a logon session of the owner (i.e., while an owner is logged in), while the steps recited below relating to enforcement of the security policy generally take place during the logon session of a user (i.e., while a user is logged in). Of course, it will be appreciated that the owner of an object can be a user of the object as well, and that security policies entered by an owner will also be evaluated against the owner as a user in this case.

At 412, the method further includes receiving a request from a user to perform an action on the securable software object, the request being received at an application programming interface of the computer operating system.

At 414, the method includes determining whether the user is authorized to perform the action on the securable software object based at least in part on an evaluation of whether the access condition is satisfied. The evaluation may be made by reference to a dynamically updatable system resource containing information for evaluating the access condition, as described above.

It will be appreciated that the step of determining whether the user is authorized to perform the action may be accomplished in part by a security subsystem that is configured to perform an access check on a function call from a thread carrying a user security context, when the thread is requesting an application programming interface of the operating system to perform an action on the securable object. As discussed above, the operating system may include an object manager associated with the securable software object, which is configured to instruct the security subsystem to perform the access check upon detecting that a user request for access has been made. Alternatively, an API at which the user request was received may be configured to instruct the security subsystem to perform the access check.

As illustrated at 418, the step of performing the access check may include querying the object security data structure in which the security policy was stored, to identify the access condition for the securable object. As illustrated at 420, the step of performing the access check may further include querying a dynamically updatable system resource for information to determine whether the access condition is met. As described above and illustrated at 424 and 426, the system resource may include dynamic system state information and/or dynamic user state information. For example, the system resource may be a system accessible clock, or a data structure containing network connection information, user manager information, user cached credential information, and/or user application and process information, as described above. Alternatively, another suitable system resource containing temporal or location based information, or other dynamic system or user state information for evaluating the access condition may be queried by the security subsystem.

As illustrated at 428, the step of performing the access check further includes evaluating whether the access condition is met based on the information. As illustrated at 430, the method further includes regulating access to the securable software object based on the evaluation of whether the access condition is met. If the outcome of step 428 is that the access condition is not met, then step 430 typically includes regulating access by denying access to the requested object. On the other hand, if the outcome of step 428 is that the access condition is met, step 430 typically includes regulating access by granting access to the object. The grant or denial of access to the object at step 430 is typically made by the security subsystem, and is communicated to the API. The API in turn communicates the grant or denial back to the requesting user thread or process, by either allowing access or sending a message that access to the requested object was denied, as discussed above.

### EXAMPLES

The following are examples of temporal access condition scenarios, which may be implemented using the systems and methods described above.

### Example 1

Company A has two manufacturing product lines, operated by two groups of employees, day shift and night shift, in each work day. Company A has strict rules on how employees may operate devices on the product lines, such as that night shift workers cannot operate machinery during the day shift, and vice versa. In this example, an owner may set access conditions based on a daily time range for each group of workers, using range selector 204 to input the start and end times, and using daily/weekly/monthly selector 208 to indicate “daily.”

### Example 2

Company A desires to limit access to an application during non-working days, such as weekends or holidays. In this example, after selecting the appropriate actions from the permissions list in screen 200, an owner may select weekend days through the repeating occurrence selector 206, or holidays through the time and date range selector 204.

### Example 3

Company A desires to reimburse employees for business related expenses only in the last week of each month, for efficiency of payment. In this example, an owner may set access conditions using period of month selector 212.

### Example 4

Company A has a manager who is approved for lab access, but needs to take a vacation. The manager, as an owner of the lab resource, may delegate his role authorizing lab access to a co-worker during the vacation, by using the time and date range selectors 204 and 205. The authorization of the co-worker will automatically stop at the expiration of the time and date range, without the manager being required to manually undo the assigned permissions.

### Example 5

Company A hires temporary workers for one month, and desires to give them temporary access to company files for one month. Like example 4, an administrator or other owner of the company files may designate access conditions that allow access during the one month period, using time and date range selectors 204 and 205. The access permissions will expire at the end of the one month period, and it will not be necessary to manually undo the assign permissions.

The following are examples of location based access condition scenarios, which may be implemented using the systems and methods described above.

### Example 6

Company A allows employees to telecommute working from home through a VPN. However, the company has sensitive data that it only allows access to if the user is authenticated via logging on to a computer on an intranet, and not from a computer connected to through a VPN. The administrator can use VPN selector 218 to enter the VPN name and restrict access to the sensitive data for users logged in through the VPN.

### Example 7

Company A has a policy not allowing users in building 18 to access printers in building 17. The owner or administrator can enter an IP address including a network address subnet corresponding to Building 18 via network address selector 216, if available. Alternatively, the location based selector may be configured to receive input of location information in another format, such as building name, and the security subsystem may be configured to compare this to location information in the user access token, or other system resource.

### Example 8

Company A gives an employee access to a file share if logged in from a machine at its headquarters in New York State, but it restricts the employee's access if the employee is logged in from a VPN. The owner or administrator may set access conditions using the IP address selector 216 by selecting an IP address that resolves to machines at the New York headquarters, and by using the VPN selector 218.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for controlling access to a securable software object in a computer operating system, the method comprising:
receiving a security policy from an owner who is authorized to control access settings for the securable software object, the security policy being at least partially based on an access condition, wherein the access condition is based on dynamic user state information or dynamic system state information having a value that is updatable while a user is logged on to the computer operating system;
receiving a request from a user to perform an action on the securable software object, the request being received at an application programming interface of the computer operating system; and
determining whether the user is authorized to perform the action on the securable software object based at least in part on an evaluation of whether the access condition is satisfied, the evaluation being made by reference to a dynamically updatable operating system resource containing a current value of the dynamic system state information or dynamic user state information.

2. The method of claim 1, wherein determining whether the user is authorized to perform the action includes:
performing an access check on a function call from a thread carrying a user security context, the thread requesting an application programming interface of the operating system to perform an action on the securable object.

3. The method of claim 2, further comprising, storing the security policy with the access condition in an object security data structure associated with the object and accessible to the security subsystem.

4. The method of claim 3, wherein performing the access check further includes:
querying the object security data structure to identify the access condition for the securable object;
querying a system resource for information to determine whether the access condition is met; and
evaluating whether the access condition is met based on the information;
and wherein the method further comprises:
regulating access to the securable object based on the evaluation.

5. The method of claim 1, wherein the access condition is a temporal condition.

6. The method of claim 5, wherein the temporal condition is based on a parameter selected from year, month, date, day and time.

7. The method of claim 1, wherein the access condition is a location based condition.

8. The method of claim 7, wherein the location based condition is based on a logical location.

9. The method of claim 8, wherein the logical location is a network address, subnet mask, network type, or active directory location.

10. The method of claim 7, wherein the location based condition is based on a spatial location.

11. The method of claim 1, wherein the system resource is selected from a system accessible clock, and a data structure containing network connection information, user manager information, user cached credential information, and/or user application or process information.

12. The method of claim 1, further comprising:
displaying a user interface having a security policy selection tool;
wherein receiving the security policy from the owner is accomplished at least in part by receiving an input of the security policy having the access condition from the owner via the security policy selection tool of the user interface.

13. The method of claim 12, further comprising displaying a temporal condition selector on the security policy selection tool, the temporal condition selector being configured to receive input of the temporal condition from the owner.

14. The method of claim 12, further comprising displaying a location parameter selector on the selection tool, configured to receive input of the location condition from the owner.

15. A system for controlling access to a securable software object in a computer operating system, the system comprising:
an object security data structure configured to contain an access condition for the securable software object, wherein the access condition is based on dynamic user state information or dynamic system state information having a value that is updatable while a user is logged on to the computer operating system;
a dynamically updatable system resource containing dynamic user state information or dynamic system state information for evaluating the access condition; and
a security subsystem that is configured to determine whether the user is authorized to perform an action on the securable software object based at least in part on an evaluation of whether the access condition is satisfied, the evaluation being made by reference to the dynamic user state information or dynamic system state information for evaluating the access condition contained in the system resource.

16. The system of claim 15, wherein the access condition is one of a plurality of access conditions in an access control list of the object security data structure.

17. The system of claim 15, wherein the system resource is one of a system accessible clock, and a data structure containing network connection information, user manager information, user cached credential information, and/or user application or process information.

18. The system of claim 15, wherein the security subsystem is configured to make the determination of whether the user is authorized to perform the action on the object, without receiving information about the access condition from an application via an application programming interface.

19. A system for controlling access to a securable software object of a computer operating system, the system comprising:
code executable to generate a graphical user interface, the graphical user interface including a security policy selection tool configured to receive input of an access condition from an owner of a securable software object, and the graphical user interface being configured to store the inputted access condition in an object security data structure for evaluation by a security subsystem of the computer operating system upon a requested action on the object by a user during a subsequent user logon session, wherein the access condition is based on dynamic user state information or dynamic system state information having a value that is updatable while the user is logged on to the computer operating system.

20. The system of claim 19, further comprising:
code executable to evaluate the access condition to regulate access to the object during the subsequent logon session of the user, by referencing a dynamically updatable system resource;
wherein the dynamically updatable system resource contains dynamic user state information or dynamic system state information for evaluating whether the temporal condition or location-based condition is met.
